(19) United States
(12) Patent Application Publication
(10) Pub. No.: US 2008/0282259 A1
(43) Pub. Date: Nov. 13, 2008

(54) DECLARATIVE CONCURRENCY AND COORDINATION SCHEME FOR SOFTWARE SERVICES

(75) Inventor: Georgios Chrysanthakopoulos, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/747,176

(22) Filed: May 10, 2007

(51) Int. Cl. G06F 9/44

(52) U.S. Cl. 719/314; 719/313

(57) ABSTRACT

A method and system are provided for declaring concurrency of the execution of one or more processes. The processes may include messages and/or methods associated with services. Messages may post to a queue in a concurrency control. Instructions are executed responsive to the posting of the messages. Any number of instructions may be executed concurrently with an underlying state. The underlying state may further be declared by an attribute. The attribute may include a service handler and may further indicate a type of concurrency control, for example, concurrent, exclusive or teardown.

### BACKGROUND

A known problem in computer science involves effective programmability around concurrency. Existing programming paradigms involve such things as threads, mutexes, semaphores, critical sections, and other primitives. Though these have been around for decades, they are hard to use properly without inducing hard-to-find timing bugs, or inadvertently serializing access through code sections via improper locking hierarchies.

In addition, synchronizing protocols associated with concurrent processes has been problematic. For example, in a multi-stage state machine that transmits messages, such as input/output messages to remote entities may need to perform functions without undue interruption. Introduction of locks may lead to deadlocks, which would be detrimental to the operation of the services.

Hence, there is a need for mechanisms to address the problem of concurrency and coordination in a concurrent and potentially distributed operating system. There is also a need for exposing a state of such processes.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In one example, a method is described for exposing a state of a process in which a plurality of messages associated with services may be received and posted on one or more queues. Instructions associated with the posted messages and queues may execute with an underlying state. The state may be exposed via an attribute.

In another example, a method is described in which messages of processes run concurrently and semantics and class of the processes or the messages are declared and/or exposed.

In another example, a computer-readable medium is described containing executable code for receiving messages from services and executing messages concurrently based on an underlying state. The underlying state may be exposed via an attribute.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates an example of a suitable computing system environment.

FIG. 2 illustrates one example of concurrency in distributed devices.

FIG. 3 illustrates an example of an attribute for providing declarative concurrency.

FIG. 4 illustrates an example of a concurrency module for providing concurrency of processed underlying an attribute.

FIG. 5 illustrates an example of an arbiter for establishing concurrency of processes.

FIG. 6 illustrates one example of a teardown receiver group.

FIG. 7 illustrates one example of an exclusive receiver group.

FIG. 8 illustrates one example of a concurrent receiver group.

FIG. 9 illustrates one example of combining interleaves.

FIG. 10 illustrates another example of the attribute for providing declarative concurrency.

FIG. 11 illustrates an example of a class for a service.

FIG. 12 illustrates one example of creating a class for a service.

FIG. 13 illustrates an example of a yield function in a processor.

FIG. 14 illustrates an example in which a processor enters a yield state.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples. Systems described herein are provided as examples and not limitations. As those skilled in the art will appreciate, the present examples are suitable for application in a variety of different types of computing systems.

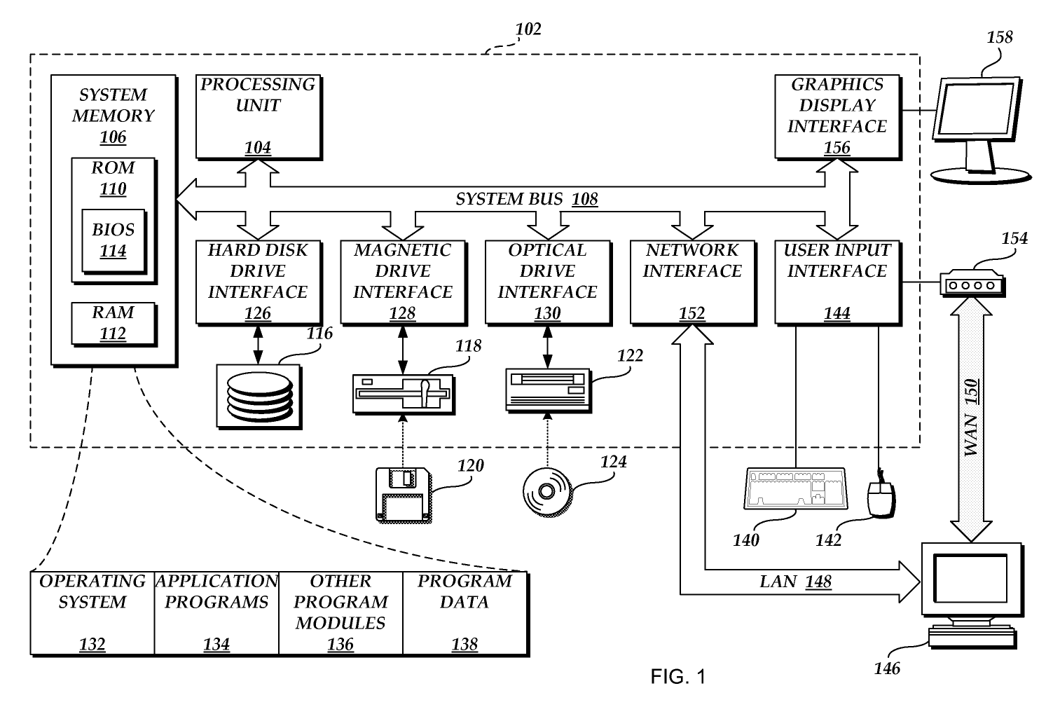

FIG. 1 illustrates an example of a suitable computing system environment or architecture in which computing subsystems may provide processing functionality. The computing system environment is only one example of a suitable computing environment and is not intended to suggest any limitation as to the scope of use or functionality of the invention. Neither should the computing environment be interpreted as having any dependency or requirement relating to any one or combination of components illustrated in the exemplary operating environment.

The method or system disclosed herein is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The method or system may be described in the general context of computer-executable instructions, such as program modules, being executed by a computer. Generally, program modules include routines, programs, objects, components, data structures, etc. that perform particular tasks or implement particular abstract data types. The method or system may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the method or system includes a general purpose computing device in the form of a computer 102. Components of computer 102 may include, but are not limited to, a processing unit 104, a system memory 106, and a system bus 108 that couples various system components including the system memory to the processing unit 104. The system bus 108 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 102 typically includes a variety of computer readable media. Computer readable media can be any available media that can be accessed by computer 102 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 102. Combinations of the any of the above should also be included within the scope of computer readable storage media.

The system memory 106 includes computer storage media in the form of volatile and/or nonvolatile memory such as read only memory (ROM) 110 and random access memory (RAM) 112. A basic input/output system 114 (BIOS), containing the basic routines that help to transfer information between elements within computer 102, such as during start-up, is typically stored in ROM 110. RAM 112 typically contains data and/or program modules that are immediately accessible to and/or presently being operated on by processing unit 104. By way of example, and not limitation, FIG. 1 illustrates operating system 132, application programs 134, other program modules 136, and program data 138.

The computer 102 may also include other removable/non-removable, volatile/nonvolatile computer storage media. By way of example only, FIG. 1 illustrates a hard disk drive 116 that reads from or writes to non-removable, nonvolatile magnetic media, a magnetic disk drive 118 that reads from or writes to a removable, nonvolatile magnetic disk 120, and an optical disk drive 122 that reads from or writes to a removable, nonvolatile optical disk 124 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 116 is typically connected to the system bus 108 through a non-removable memory interface such as interface 126, and magnetic disk drive 118 and optical disk drive 122 are typically connected to the system bus 108 by a removable memory interface, such as interface 128 or 130.

The drives and their associated computer storage media discussed above and illustrated in FIG. 1, provide storage of computer readable instructions, data structures, program modules and other data for the computer 102. In FIG. 1, for example, hard disk drive 116 is illustrated as storing operating system 132, application programs 134, other program modules 136, and program data 138. Note that these components can either be the same as or different from additional operating systems, application programs, other program modules, and program data, for example, different copies of any of the elements. A user may enter commands and information into the computer 102 through input devices such as a keyboard 140 and pointing device 142, commonly referred to as a mouse, trackball or touch pad. Other input devices (not shown) may include a microphone, joystick, game pad, pen, scanner, or the like. These and other input devices are often connected to the processing unit 104 through a user input interface 144 that is coupled to the system bus, but may be connected by other interface and bus structures, such as a parallel port, game port or a universal serial bus (USB). A monitor 158 or other type of display device is also connected to the system bus 108 via an interface, such as a video interface or graphics display interface 156. In addition to the monitor 158, computers may also include other peripheral output devices such as speakers (not shown) and printer (not shown), which may be connected through an output peripheral interface (not shown).

The computer 102 may operate in a networked environment using logical connections to one or more remote computers, such as a remote computer. The remote computer may be a personal computer, a server, a router, a network PC, a peer device or other common network node, and typically includes many or all of the elements described above relative to the computer 102. The logical connections depicted in FIG. 1 include a local area network (LAN) 148 and a wide area network (WAN) 150, but may also include other networks. Such networking environments are commonplace in offices, enterprise-wide computer networks, intranets and the Internet.

When used in a LAN networking environment, the computer 102 is connected to the LAN 148 through a network interface or adapter 152. When used in a WAN networking environment, the computer 102 typically includes a modem 154 or other means for establishing communications over the WAN 150, such as the Internet. The modem 154, which may be internal or external, may be connected to the system bus 108 via the user input interface 144, or other appropriate mechanism. In a networked environment, program modules depicted relative to the computer 102, or portions thereof, may be stored in the remote memory storage device. By way of example, and not limitation, remote application programs may reside on a memory device. It will be appreciated that the network connections shown are exemplary and other means of establishing a communications link between the computers may be used.

A method and system is described in which any number of applications or services may be performed or executed either exclusively to itself or concurrently in any node or combination of nodes. Also, any number of services may be associated with processes that may execute and may be performed either exclusively or concurrently with other processes. Also, any of the services may include interfaces through which communication of various components in the performance of a function may occur.

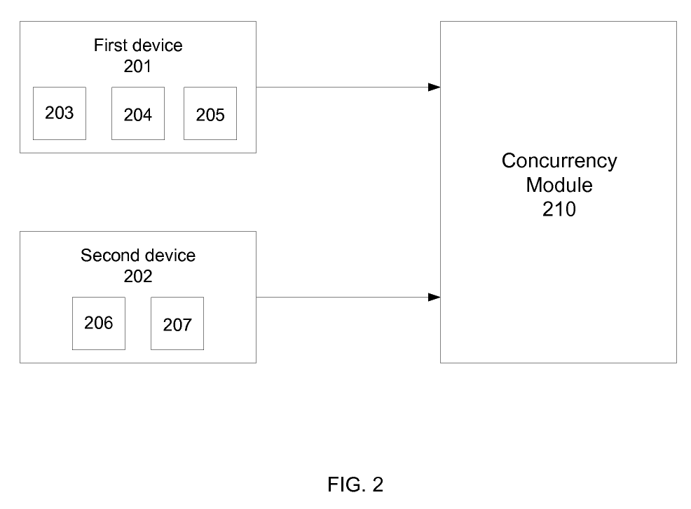

FIG. 2 illustrates one example of concurrency in distributed devices. In this example, a network of inter-operational, distributed devices may include at least a first device 201 and a second device 202. Any number or type of processes may be associated with any of the devices. The first device 201 in FIG. 2 is illustrated as including three processes 203, 204, 205 and the second device 202 is illustrated as including two processes 206, 207. However, any number or type of processes may be included in any of the device. The processes (203, 204, 205) of the first device 201 may include any number of instructions for performing any number of functions. Similarly, the processes (206, 207) of the second device 202 may also include any number of instructions for performing any number of functions. Alternatively any number of multiple processes may be performed within a single device. These processes may be executed concurrently. The devices may be any type of device including, but not limited to, computers, modules, programs, robots, etc.

Control of the functions and/or instructions of the functions in any of the devices may be performed such that any of the devices are coordinated according to a desired or predetermined scheme. For example, through execution of an instruction of a process (203, 204, 205) in the first device 201, a message may received at a concurrency module 210. Similarly, additional messages may be received at the concurrency module 210 form any of the processes of any of the devices. Based on the received message, corresponding instructions may be executed concurrently. In this example, a determination as to which process of different devices may be made such that the processes may be accomplished concurrently. Also, any number and any type of entities may be coordinated.

Each component or entity providing a service may be executing substantially simultaneously or concurrently with any number of other instructions, services or messages from any number or type of other components or entities. Also, any of the services may adopt any number of states. The state of a service may describe a condition of the service at any particular point in time. The conditions may vary, for example, based on the activities or any parameters associated with the service.

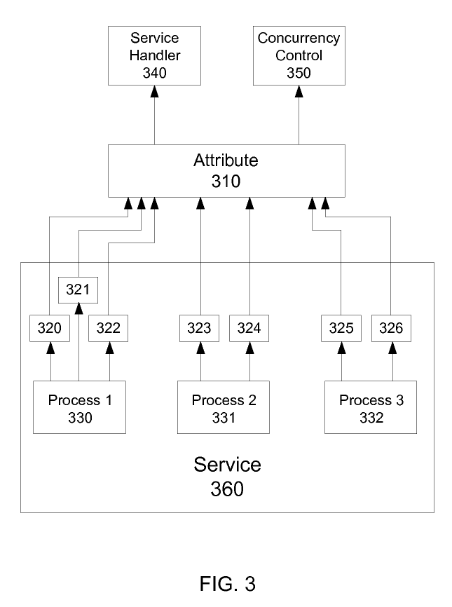

FIG. 3 illustrates an example of an attribute for providing declarative concurrency. In this example, an attribute 310 is provided that may annotate methods (e.g., methods 320, 321, 322, 323, 324, 325, 326) executed in various processes (e.g., processes 330, 331, 332). The attribute 310 may further provide declarative concurrency while functioning as a service handler 340 and/or indicating types of concurrency control 350. Hence, the attribute 310 may elevate certain methods (e.g., 320, 321, 322, 323, 324, 325, 326) of processes (e.g., 330, 331, 332) in a service 360 and may further bring the elevated methods to the attention of underlying concurrency operations. In another example, the attribute 310 facilitates coring up state of a process. For example, a user may start a service 360 which may further execute a process (e.g., process 330, 331, or 332). The process may identify handlers corresponding to the service via the attribute 310 and may further generate any number of primitives for providing concurrency (e.g., concurrency control 350).

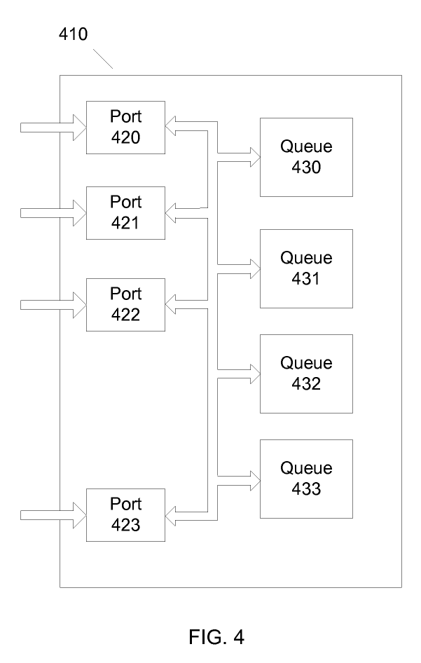

Control or management of such services may be provided by processes, policies and/or functions underlying the attribute such as a concurrency module. FIG. 4 illustrates an example of a concurrency module for providing concurrency of processed underlying an attribute. The concurrency module 410 in the example of FIG. 4 may store any instructions for any number of processes and may further contain any number of ports (e.g., ports 420, 421, 422, 423) which may receive messages from any number of services. In addition, the concurrency module 410 may include one or more queues (e.g., queues 430, 431, 432) in which messages may be posted. For example, messages or instructions may post to a queue and, responsive to posting messages to the queue or, alternatively, satisfaction of any desired condition, instructions may be spawned. Thus, instructions may be attached that run independently when messages are received.

Input/output (I/O) instructions from any number or type of service may be managed concurrently via any number of ports (e.g., ports 420, 421, 422, 423). The ports may include data or information that may be stored in a queue structure. For example, an asynchronous I/O operation may execute and provide a result item that may post to the port (e.g., port 420). The port (e.g., port 420) may also include a receiver task for processing the result item via an arbiter class method. In one example, the concurrency module 410 may manage concurrency by specifying a multi-stage state machine that may send messages to remote entities. Hence, in this example, I/O is considered messages and some behavior is run exclusive to other behavior. A class and corresponding methods of the type found in the queue may be created.

In yet another example, a message may be specified as state site affecting via semantics of the message. Semantics are used to characterize names of components of the messages where the names may be derived from predetermined operation types in which the concurrency module may enforce. Hence, any application may be considered to be a service sending messages. The application in this illustration may further act as a coordinator for characterizing messages that are posted on the queue.

In another example, the semantics of an attribute may be applied to a variety of coordination mechanisms. For example, an arbiter may implement coordination primitives over queues or execute user code responsive to a variety of events. Many classes of arbiters may be used. For example, a simple arbiter may receive a single item receive. Other arbiters may be more complex and may implement declarative concurrency (e.g., interleave) or may permit nesting. Any arbiter class may also run under the attribute and may further define any number or type of methods. The methods defined by an arbiter class may create any number or type of other objects. Any type of arbiter class may be used. One example of an arbiter class may include a receive arbiter that may indicate a method to process a single item from a single port or a multiple receive arbiter that may indicate a method to process multiple items from a port. These are merely examples as any arbiter class may be used.

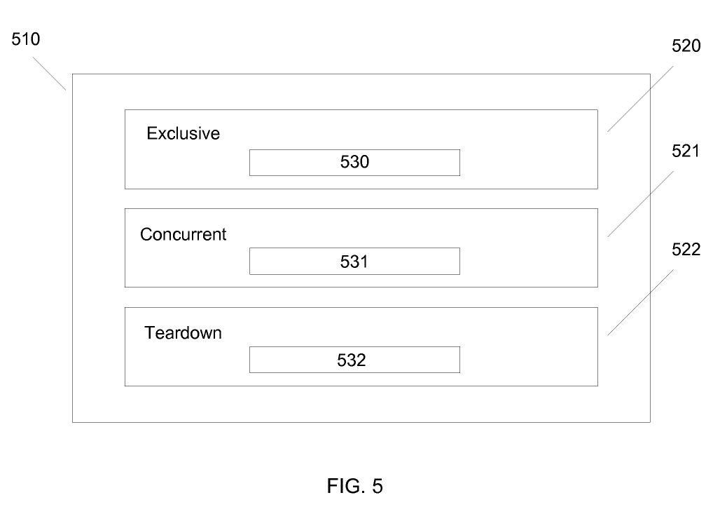

FIG. 5 illustrates an example of an arbiter for establishing concurrency of processes. This example includes an example of an interleave arbiter or primitive. The interleave arbiter 510 may describe any number of concurrent calculations or other operations to be performed by capturing a pattern corresponding to multiple reads but single writers to a shared state. The interleave arbiter 510 may further permit the formation of a group of receivers (e.g., receivers 520, 521, 522) . Examples of receiver groups identified by the interleave arbiter may include an exclusive receiver group 520, a concurrent receiver group 521, or a teardown receiver group 522, to name a few. Although the interleave arbiter 510 illustrated in FIG. 5 shows three receiver groups, an interleave arbiter may contain any number of groups. The interleave arbiter 510 may further run under the attribute (e.g., attribute 310, FIG. 3) and may protect until the termination of the state machine. Each receiver group (e.g., 520, 521, 522) may include any number or type of receivers. A receiver may further be created (e.g., via arbiter receive 530, 531, 532) which may further characterize a corresponding receiver (e.g., 520, 521, 522). For example, the arbiter receive 531 of the concurrent receiver group 521 may specify a main port corresponding to a receiver in the concurrent receiver group 521.

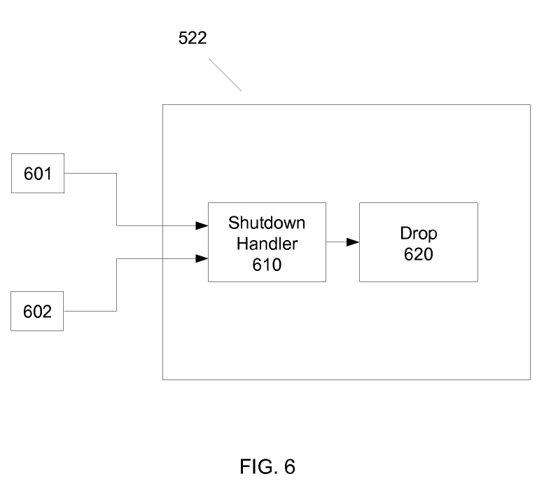

One example of a receiver type is the teardown receiver group (receiver group 522, FIG. 5) in which a join may be used to receive an item at a first port and an item at a second port. FIG. 6 illustrates one example of a teardown receiver group. In this example, the teardown receiver group 522 receives two items (601, 602) which may trigger the execution of instructions or operations associated with a service. For example, the first item 601 may include a first condition to be satisfied prior to execution of desired instructions and the second item 602 may include a second condition to be satisfied prior to execution of the desired instructions. In this example, teardown may include a shutdown handler 610 that may take a message type such that the service or operation may terminate or “drop” (e.g., drop 620).

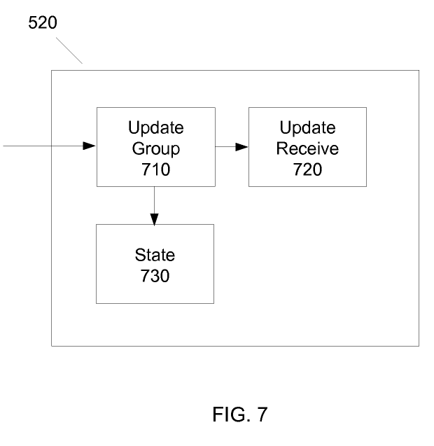

In another example illustrated in FIG. 7, the receiver group includes an exclusive receiver group 520 in which a receiver may be generated from an update group 710 such that an update receiver 720 may be created under an exclusive receiver in the exclusive receiver group 520. Instructions and operations associated with a desired service may execute under the exclusive receiver group 520. Furthermore, execution of the operations under the exclusive receiver group 520 may alter the state 730 of the receiver group.

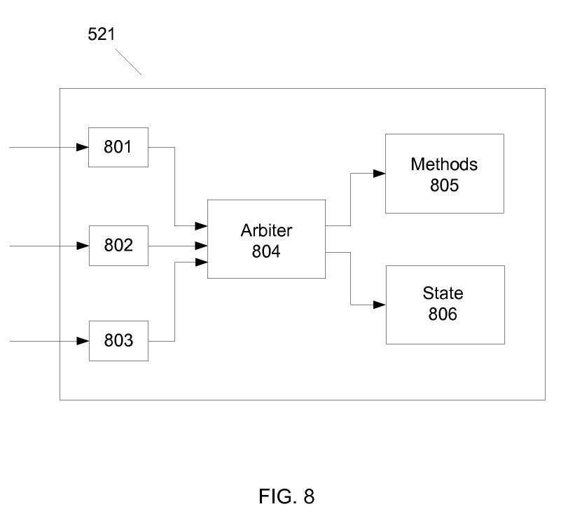

In another example illustrated in FIG. 8, the receiver group includes a concurrent receiver group 521 in which an arbiter 804 may be specified for performing a method (e.g., methods 805) upon receipt or posting of a message at a specified port (e.g., ports 801, 802, 803). In addition, the data may be persistent (such that operations may be repeated) or non-persistent (such that operations may terminate after one execution). Similarly, state 806 of the concurrent receiver group 521 may be altered by the execution of operations under the concurrent receiver group 521.

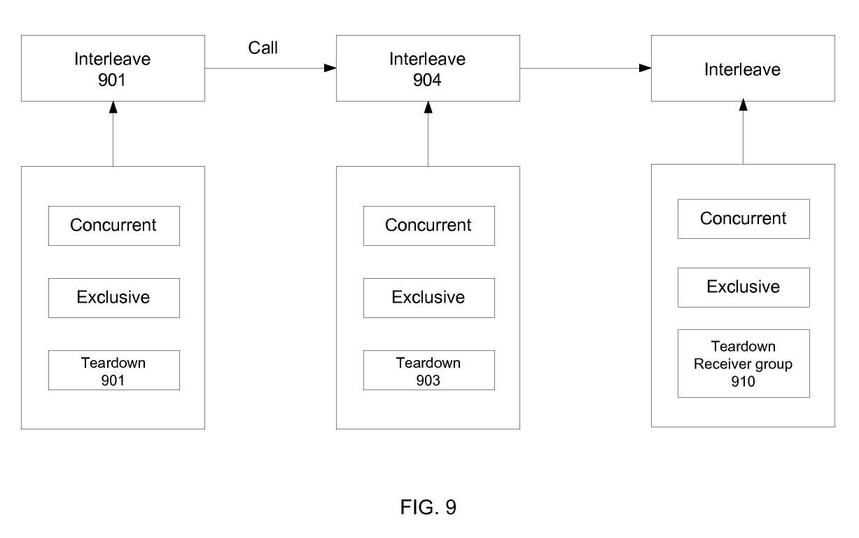

Multiple interleaves may also be combined to form larger interleaves. FIG. 9 illustrates one example of combining interleaves. This may occur when an interleave has a call with another interleave, for example. Hence, a state machine may combine with a main service coordination. In another example, teardown receiver groups from different interleaves may be combined into a single interleave for a single call. As FIG. 9 illustrates, teardown receiver group 901 from a first interleave 902 is combined with teardown receiver group 903 from a second interleave 904. The resultant interleave 905 contains teardown receiver group 910, which is a combination of the teardown receiver group 901 from the first interleave 902 and the teardown receiver group 903 from the second interleave 904.

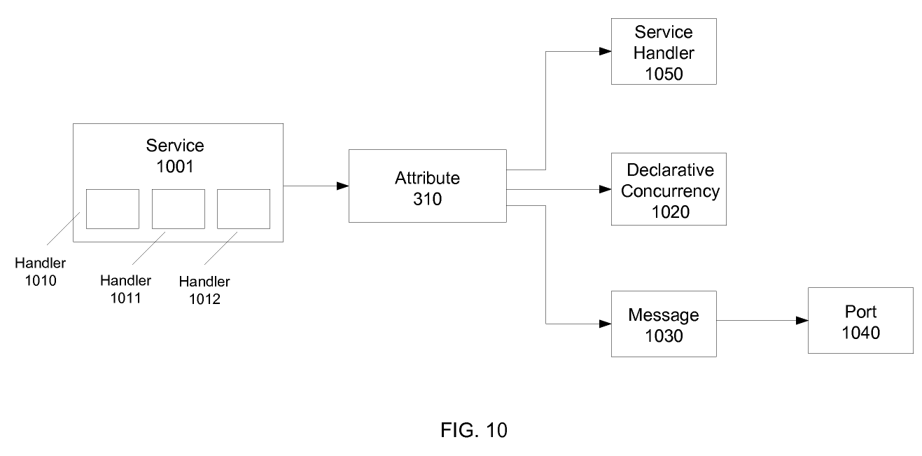

FIG. 10 illustrates another example of the attribute for providing declarative concurrency. In this example, a service 1001 is examined to identify handlers (e.g., handlers 1010, 1011, 1012) associated with the service 1001. The attribute 310 may be used in identifying the handlers (e.g., handlers 1010, 1011, 1012) in the service (1001). The attribute 310 in this example, provides declarative concurrency 1020 and may effectively hide lengthy instructions, thus simplifying the process. In one example, the attribute 310 may provide a message 1030 such as a “GET” message on a port 1040. Additionally or alternatively, the attribute 310 may indicate the message or instruction as one of the service handlers 1050 for execution in a thread context responsive to receiving a specified message.

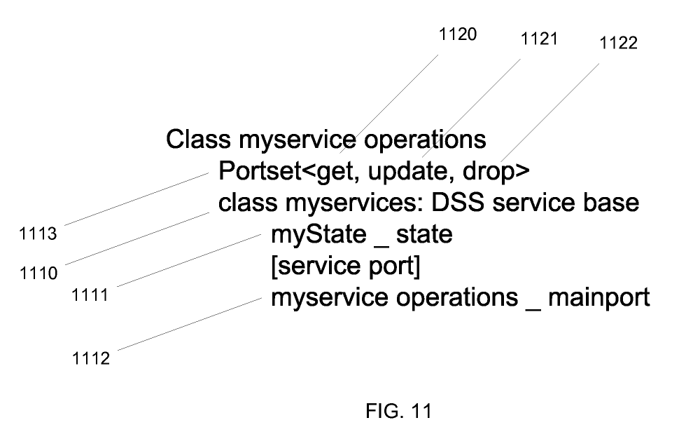

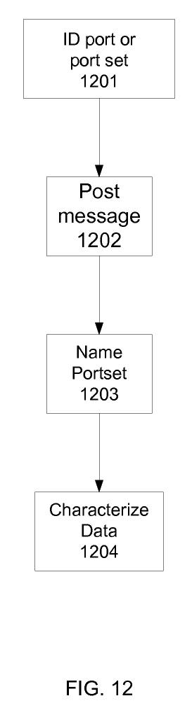

FIG. 11 illustrates an example of a class for a service and FIG. 12 illustrates one example of creating a class for a service. The class illustrated in FIG. 11 includes a “myservice” class 1110 which may include a service having state “mystate” 1111. The state includes a field having ports. In this case, one port is “main port” and is referenced as “myserviceoperations” 1112. In another example, a port set 1113 may be specified for the class 1110. The port set 1113 may include any number of queues (e.g., queues 1120, 1121, 1122). In this example, the port set 1113 has three queues: get 1120, update 1121 and drop 1122. Hence, the port set 1113 in this example can post messages (get 1120), update the messages (update 1121) and drop the messages (drop 1122). The portset 1113 illustrated in FIG. 11 is merely one example of a port set as any number or type of queues may be included in the port set. FIG. 12 is a flowchart illustrates a method for creating a class for a service. In STEP 1201, a port set is identified. The port set in STEP 1202 contains messages in the port set. The port set may be named (STEP 1203), e.g., as a main port. In the example illustrated in FIG. 11, the port set is named “myserviceoperations” 1112. Also, as illustrated in STEP 1204, additional characterizing data may be inserted to describe additional features of the ports. At runtime in this example, the process may be bound to a network with any number of transports. Any number or type of messages, such as serialized messages, may be received. The messages may further be cloned internally resulting in state, a port or port set, behavior and/or code.

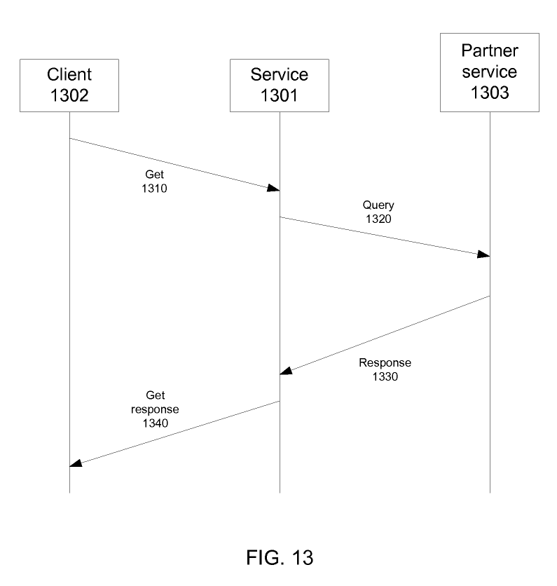

Any service may further include a yield function, IEnumerator function and/or get handler. When a yield function is invoked, a break in execution of instructions may occur without a break in a thread in which execution of the operations may be interrupted, at least temporarily. A breakpoint may be set (e.g., during debugging) such that after a yield, the compiler may continue compiling with no threads blocked. This may permit scaling to many work items while still performing sequential protocols. In a yield, functions may be logically blocked for a logical execution in a logical execution context. FIG. 13 illustrates an example of a yield function in a processor. In this example, a client 1302 communicates with a service 1301 with a get message 1310. The service may be identified as having a state. The state may include, for example, a field having main ports, or alternatively, a port set having any number of queues in which messages may be posted and/or executed. The get message 1310 may be received at the service 1301 but further information may be needed at the service 1301 from another service such as a partner service 1303 prior to responding to the client 1302. Therefore, a query 1320 may be sent to the partner service 1303. For example, the service 1301 may post the query 1320 on a port of the partner service 1303. The query 1320 may further include a primitive choice, for example, having any number or type of delegates, being assigned a stack value, and/or taking the port. While in the yield state, the service 1301 may perform any other tasks on another queue (e.g., a dispatcher queue).

The process may wait for the receipt of a response 1330 (e.g., from partner service 1303) before proceeding to a responding to the client 1302 with a get response 1340. In this example, a message may be sent with a subsequent yield return on a receiver. In this example, no matter how many messages are received, any number of messages or instructions may execute concurrently or asynchronously.

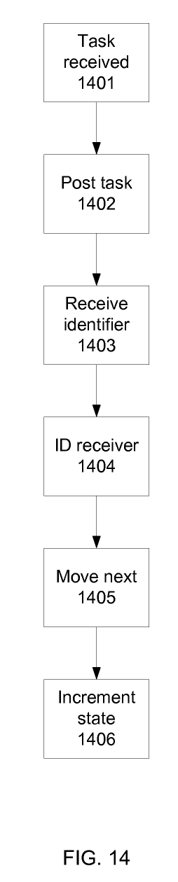

FIG. 14 illustrates an example in which a processor enters a yield state. In this example, a task is received that blocks state (STEP 1401). The task may be posted on a port (STEP 1402). An identifier, such as a GUID, may be received associated with a message and a corresponding port waiting for a response (STEP 1403). Based on the identifier and/or corresponding message, a corresponding port may be identified as waiting for a response. A receiver associated with the port as awaiting a response may be identified (STEP 1404). In STEP 1405, the concurrency module moves the identified receiver to the next stage. In one example, a “move next” is executed to move the receiver to the next stage. State is incremented in the class (STEP 1406) and a corresponding method is invoked.

Additionally or alternatively, an interleave may be active containing underlying state. The state corresponding to the interleave may be provided such that other processes that may execute concurrently may be executed. For example, a state of a process or service may execute a concurrent handler corresponding to a concurrent state of the process or service. Other concurrent processes or services may also be executing. Any of the operations associated with the multiplicity of processes or services may be executed concurrently or asynchronously.

In addition, the handler (e.g., service handler) may send an update message. The update message may update a receiver to a new (or updated) state. In one example, the update message may not execute during temporary yields. For example, a process may yield such the execution of the process has been temporarily suspended while waiting for a result from another service or process. In this case, if an update message is received corresponding to the process, the update message may be deferred until the process has completed.

A method and system is described of a declarative attribute for annotating methods for managing concurrency. The attribute may declare corresponding semantics of the process such that a state of the corresponding process or service may be exposed (e.g., if the service is a concurrent service, exclusive service, teardown, etc.). State and behavior may be separated via services. For example, state may be made available by execution of any type of operations in a Decentralized System Services (DSS) implementation, including but not limited to GET, UPDATE, QUERY, etc. The attribute may be used in a handler for any message. One example of such a message is a GET message in which the handler may post the state of a corresponding service to a response port of a message. The attribute may be used in a method to identify member functions as message handlers for messages posted to a main service port. In addition, the attribute may also indicate an iterator to permit a handler to contain a sequence of asynchronous actions without blocking a thread.

In one example, the attribute may expose a state of a service in a method. The following illustrates an example of the attribute used in a Get message. The attribute in this example specifies a message handler as using read-only access to the state of a service and permitting message handlers not modifying state to run concurrently:

```
[ServiceHandler(ServiceHandlerBehavior.Concurrent)]
public IEnumerator<Itask> Gethandler (Get get)
{
    get.ResponsePort.Post(_state);
    yield break;
}
```

In another example, the attribute may also be used in an HTTPGET handler as follows:

```
[ServiceHandler(ServiceHandlerBehavior.Concurrent)]
public IEnumerator<Itask> HttpGethandler (HttpGet httpGet)
{
    get.ResponsePort.Post(new HttpResponseType(_state));
    yield break;
}
```

In yet another example, the attribute is used in a replace message:

```
[ServiceHandler(ServiceHandlerBehavior.Exclusive)]
public IEnumerator<ITask> ReplaceHandler(Replace replace)
{
    _state = replace.Body;
    replace.ResponsePort.Post(DefaultReplaceResponseType.Instance);
    yield break;
}
```

As can be seen above, in this example, the handler is indicated as capable of modifying state. For example, one exclusive handler executes at a time and concurrent handlers may not execute while an exclusive handler is running.

It is understood that aspects of the present description can take many forms and embodiments. The embodiments shown herein are intended to illustrate rather than to limit the description, it being appreciated that variations may be made without departing from the spirit of the scope of the invention. Although illustrative embodiments have been shown and described, a wide range of modification, change and substitution is intended in the foregoing disclosure and in some instances some features may be employed without a corresponding use of the other features. Accordingly, it is appropriate that the appended claims be construed broadly and in a manner consistent with the scope of the invention.

1. A method for exposing a state of a process for declarative concurrency control, the method comprising:
receiving a plurality of messages corresponding to at least one process of at least one service;
posting each of the messages at a corresponding queue;
executing a plurality of instructions responsive to the posting, the executing associated with a state; and
exposing the state via an attribute, the attribute including declarative concurrency control.

2. The method of claim 1 wherein executing the plurality of instructions includes executing the plurality of instructions concurrently.

3. The method of claim 1 wherein the attribute includes a service handler and a concurrency control.

4. The method of claim 3 wherein the attribute identifies methods in the plurality of messages and elevates the identified methods.

5. The method of claim 1 wherein the state includes an interleave for forming one or more receivers associated with the at least one process.

6. The method of claim 5 wherein the one or more receivers includes at least one queue.

7. The method of claim 6 wherein the at least one queue is selected from the group consisting of teardown, exclusive, and concurrent.

8. A method for providing information of managing messages from services, the method comprising:
managing messages of one or more processes running concurrently;
declaring semantics associated with the managing;
exposing a class associated with the managing.

9. The method of claim 8 wherein declaring includes generating an attribute and declaring the semantics via the attribute.

10. The method of claim 9 wherein the semantics includes a state corresponding to the managing of messages.

11. The method of claim 10 wherein the state includes at least one of an exclusive state, a concurrent state, or a teardown state.

12. The method of claim 10 wherein the managing step includes executing a plurality of messages concurrently, the attribute further declaring a yield, the yield indicating a break in execution of a message of the plurality of messages.

13. The method of claim 9 further comprising:
identifying at least one handler associated with the one or more processes via the attribute; and
creating an interleave responsive to identifying the at least one handler, the interleave running under the attribute.

14. The method of claim 13 further comprising one or more receivers via the interleave.

15. The method of claim 9 wherein exposing the class comprises generating an attribute and indicating a type of concurrency control via the generated attribute.

16. The method of claim 15 wherein the attribute further indicates a service handler, the service handler for executing at least one message of the one or more processes.

17. A computer-readable medium having executable code for performing the following steps:
receiving one or more messages from one or more services;
sending a query to a partner service responsive to receiving the one or more messages;
receiving a query response from the partner service responsive to the query;
executing the one or more messages concurrently based on an underlying state, the underlying state indicating a type of execution;
exposing the underlying state via an attribute.

18. The computer-readable medium of claim 17 wherein exposing the underlying state includes declaring the service as a concurrency service.

19. The computer-readable medium of claim 17 wherein exposing the underlying state further comprises identifying one or more handlers associated with the one or more services and executing the identified one or more handlers in an arbitrary thread context.

20. The computer-readable medium of claim 19 wherein the one or more handlers posts the underlying state of the one or more services to a response port of the one or more messages.
